(19) United States
(12) Patent Application Publication
(10) Pub. No.: US 2003/0236764 A1
(43) Pub. Date: Dec. 25, 2003

(54) Data architecture to support shared data resources among applications

(76) Inventor: Lev Shur, Walnut Creek, CA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/268,302

(22) Filed: Oct. 9, 2002

Related U.S. Application Data
(60) Provisional application No. 60/390,063, filed on Jun. 19, 2002.

(51) Int. Cl. G06F 17/30

(52) U.S. Cl. 707/1

(57) ABSTRACT

A data architecture and method that supports shared access to data among multiple applications. The architecture includes sets of data entities, data properties, data relationships, and data mappings. Each data entity has a defined data property. The data relationships define relationships between data entities, such as RDBMS relationships and flat file relationships. The data mappings, along with associated data access mechanisms, provide a means for mapping data from one or more existing data entities corresponding to existing applications into data entities for new applications and new data entities for existing applications. The novel data architecture of the invention breaks apart the one-to-one linking between architecture elements imposed by conventional data architectures, thereby enabling applications to not only share access to the same data, but to define their own relationships and usage for such data.

### RELATED APPLICATIONS

The present application is based on a co-pending provisional application entitled “SEPARATION OF DATA ARCHITECTURE ELEMENTS,” Ser. No. 60/390,063, filed on Jun. 19, 2002, the benefit of the filing date of which is claimed under 35 U.S.C. §119(e).

### FIELD OF THE INVENTION

The field of invention relates generally to data applications and systems and, more specifically but not exclusively relates to a data architecture that supports sharing of data resources across applications.

### BACKGROUND INFORMATION

The cornerstone of modern application design and development is the concept of “data ownership”. It is implicitly assumed that an application “owns” its data. In other words, the application logically and physically controls the data. The only safe way to access or modify any data is through the application itself (or through an application-defined API). As a rule, if any other sources of data need to be accessed, then the data must be replicated into an application-controlled data store.

It is known to those skilled in the art that every software application has data architecture. Data architecture is a combination of the methodology and software tools that facilitate definition, access and manipulation of the data by software applications.

Data architecture covers both data modeling (design time) and data delivery (run time). That is,

Data architecture=data model+data delivery.

In turn, data model and data delivery can be presented in the following way:

Data model=data entities+data properties+data relationships

Data delivery=data access+data storage.

Thus, data architecture can be presented as the following building blocks:

Data architecture=data entities+data properties+data relationships+data access+data storage.

FIG. 1 shows a simple example of the data architecture of a conventional software application. In FIG. 1, application 100 comprises data entity 110 (“Hello World”), data property 111 (string, 12 characters), and a null data relationship 112 (since there is only one data item). The data storage 114 is computer memory and data access is provided by a data access mechanism 113L, which typically comprises a data link facilitated by the I/O capabilities of the programming language and operating system.

FIG. 2 shows another, more typical example of modern data processing applications. In FIG. 2, data entity 110, data property 111, and data relationships 112 all reside in data storage 114, again linked to application 200 by data access mechanism (link) 113L. Almost all such modern data processing applications are based on the relational data model and use one of the many relational database management system (RDBMS) implementations currently available. Data entities 110 are presented as data fields (i.e., database table columns); data properties 111 are type, length, etc.; data relationships 112 are defined through relational algebra operations; and data access mechanism 113L and data storage 114 are provided by the RDBMS implementation.

This approach gives application designers and developers the full freedom to define the application data architecture without taking into account any other application and data stores that potentially use the same information. While it simplifies the life of application designers and developers, it makes implementation very complicated, because the reality of the modern information technology is that no application is an island. In current enterprise environments, multiple applications need to work together and reuse data among themselves.

What is clearly needed is a new architecture scheme that supports shared data resources across multiple applications without requiring replicating and/or synchronizing multiple data stores, wherein the new architecture no longer is restricted by the one-to-one relationship paradigm employed by the conventional architecture, but rather separates the five building blocks of application data architecture (data entities, data properties, data relationships, data access, data storage) and breaks the one-to-one relationship among them.

### SUMMARY OF THE INVENTION

In accordance with aspects of the present invention a data architecture and method that supports shared access to data among multiple applications is disclosed. The architecture includes sets of data entities, data properties, data relationships, and data mappings. Each data entity has a defined data property. The data relationships define relationships between data entities, such as RDBMS relationships and flat file relationships. The data mappings, along with associated data access mechanisms, provide a means for mapping data from one or more existing data entities corresponding to existing applications into data entities for new applications and new data entities for existing applications. The novel data architecture of the invention breaks apart the one-to-one linking between architecture elements imposed by conventional data architectures, thereby enabling applications to not only share access to the same data, but to define their own relationships and usage for such data.

In accordance with another aspect of the invention, a method is disclosed for mapping logical data transactions corresponding to a logical data model into existing physical data transactions provided by one or more existing application and corresponding to that/those applications' physical data model(s). Under the method, a set of logical data transactions employing a first set of data elements corresponding to a logical data model for an application is defined. A set of physical data transactions employing a second set of data elements corresponding to a physical data model for an existing application are also identified. A set of logical-to-physical data transaction mappings may then be defined, each comprising a set of operations and data transformations that link the logical transactions with one or more physical transactions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a conventional data architecture in which data entities, properties and relationships are managed by an application;

FIG. 2 is a schematic diagram illustrating another conventional data architecture corresponding to a modern relational database management system (RDBMS) model in which the data entities, properties and relationships are managed by the RDBMS.

FIG. 3a is a schematic diagram illustrating an exemplary data architecture in accordance with an embodiment of the invention;

FIG. 3b is a schematic diagram illustrating details of an embodiment in which existing data entities having different data properties may be mapped into the same data entity;

FIG. 4 is a schematic diagram illustrating another exemplary data architecture in accordance with an embodiment of the invention;

FIG. 5 is a schematic block diagram illustrating a logical-to-physical data transaction mapping scheme in accordance with aspects of the invention;

FIG. 6 is a listing of physical transactions and operations corresponding to the logical data transaction set of FIG. 5;

FIG. 7a is an execution flow diagram illustrating a series of physical transactions and data operations that are performed corresponding to the logical data transaction set of FIG. 5 in which caching data elements is not employed;

FIG. 7a is an execution flow diagram illustrating a series of physical transactions and data operations that are performed corresponding to the logical data transaction set of FIG. 5 in which caching data elements is employed;

FIG. 8 is an exemplary distributed execution environment corresponding to the data architecture embodiment of FIG. 4; and

FIG. 9 is a schematic diagram of an exemplary computer server that may be employed for executed software to perform aspects of the invention corresponding to the embodiments of the invention disclosed herein.

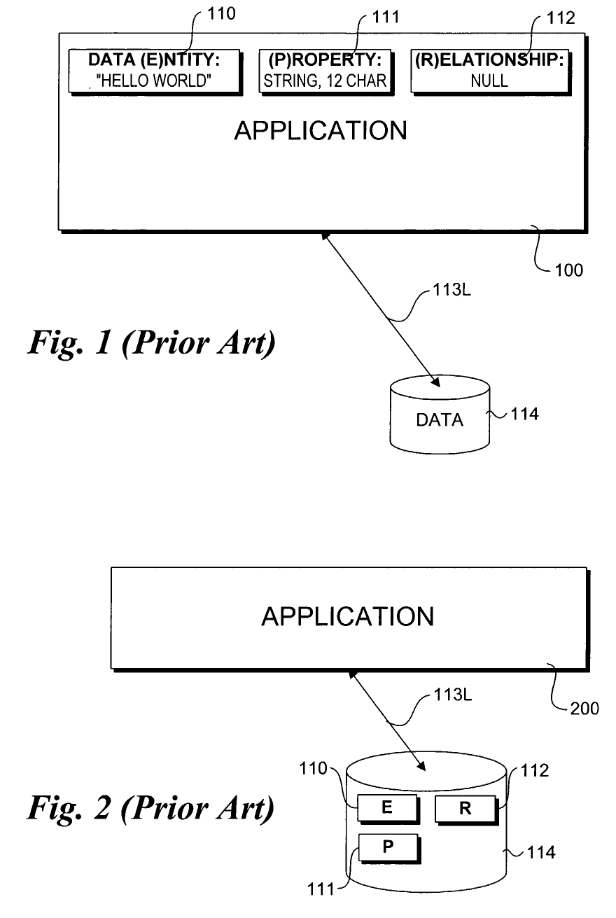

### DETAILED DESCRIPTION OF PREFERRED EMBODIMENTS

Embodiments of method and architecture that supports sharing of data resources across resources that access and/or use the data in different manners are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

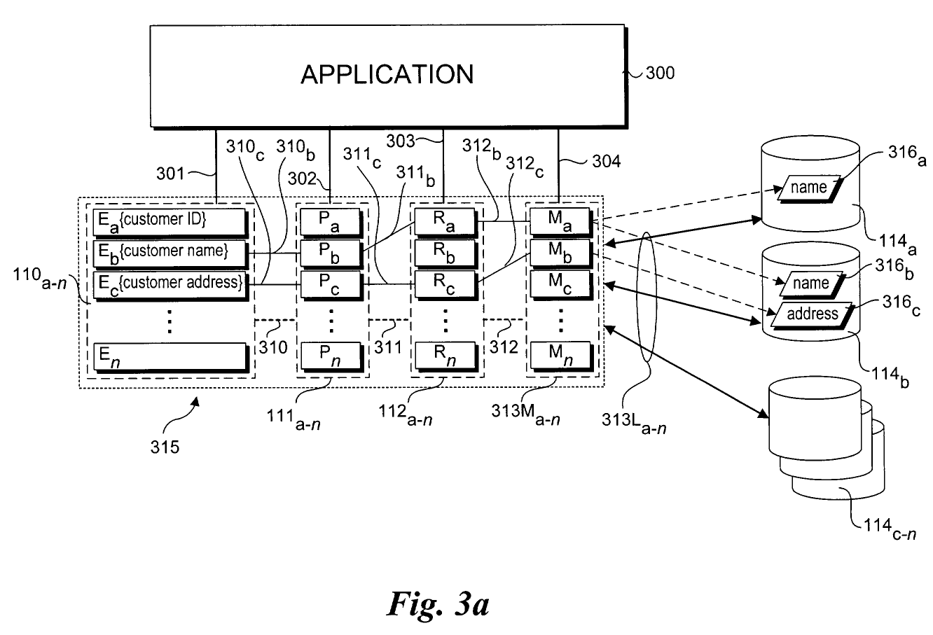

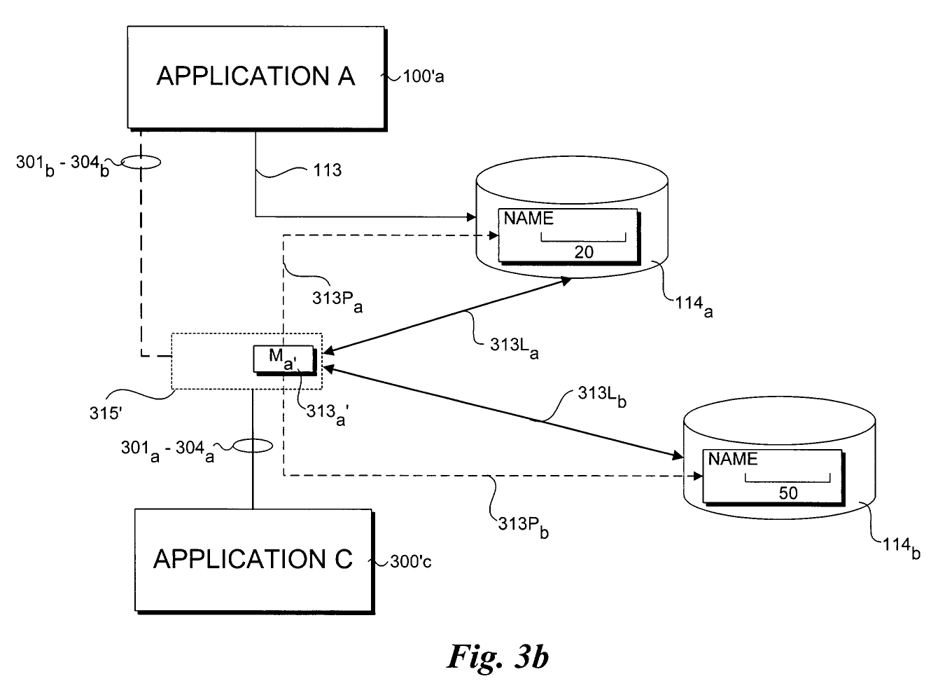

An exemplary implementation of a data architecture in accordance with an embodiment of the invention is shown in FIG. 3a. In this example, a customer information application 300 is provided access to data stored in various data stores 114ₐ₋ₙ via a data architecture matrix 315. In general, data architecture matrix includes four groups of elements, including data entities 110ₐ₋ₙ, data properties 111ₐ₋ₙ, data relationships 112ₐ₋ₙ, and data maps 313Mₐ₋ₙ. For the sake of simplicity and clarity, only three data entities are fully depicted in view of the n possible data entities used by the customer information application, including a customer ID data entity (Eₐ), a customer name data entity (E_{b}) and a customer address data entity (E_{c}). It is noted that the subscripts n included on the various reference numbers herein are used to indicate that each group of elements may include a variable number of elements, wherein the number of elements in the groups do not have to be equal, although that possibility exists as well.

Lines 301, 302, 303, and 304 represent adaptive links that permit data access to data architecture matrix 315. Bars 310, 311, and 312 represent general set relationships between the element groups, while bars 310ₙ, 311ₙ, and 312ₙ represent specific set relationships identifying members of a related set of elements. For example, in accordance with application 300, data entity E_{b} has a property P_{b}, may be related to one or more other data entities based on relationships Rₐ, and the data corresponding to data entity Eₐ is stored in data stores 114ₐ and 114_{b} as data 316ₐ and 316_{b} whose location/identification is defined by a data map Mₐ, as depicted by set relationships 310_{b}, 311_{b} and 312_{b}. Similarly, data entity E_{c} has a property P_{c}, may be related to one or more other data entities based on relationships R_{c}, and the data corresponding to the data entity is stored in data store 114_{b} as data 316_{c} which maybe accessed or identified via data mapping M_{b}, as depicted by set relationships 310_{c}, 311_{c} and 312_{c}.

FIG. 3b shows an example of two applications, 100′a and 300′c, which, by means of the novel art of this disclosure may access data from multiple data storage 114ₐ and 114_{b}. Application 100′a has, for example, a customer name field 20 characters long; while application 300′b has a customer name field 50 characters long.

Through data links 301_{b}-304_{b}, application 300′c may access the data architecture matrix 315′, comprising elements 110ₐ₋ₙ, 111ₐ₋ₙ, 112ₐ₋ₙ, and 313ₐ₋ₙ (not shown) and set relationships 310ₙ-312ₙ. Data map 313ₐ′ permits application 300′b to access data storage 114ₐ for any names that use the 20-character name fields, plus data storage 114_{b} for any names that use the 50-character name fields, as depicted by data paths 313Pₐ and 313P_{b}. Moreover, although application 100′a now only accesses data storage 114ₐ via data access link 113, at some future time application 100′a may be configured to access data architecture matrix 315′ via links 301_{b}-304_{b}, shown as a dotted line in FIG. 3b.

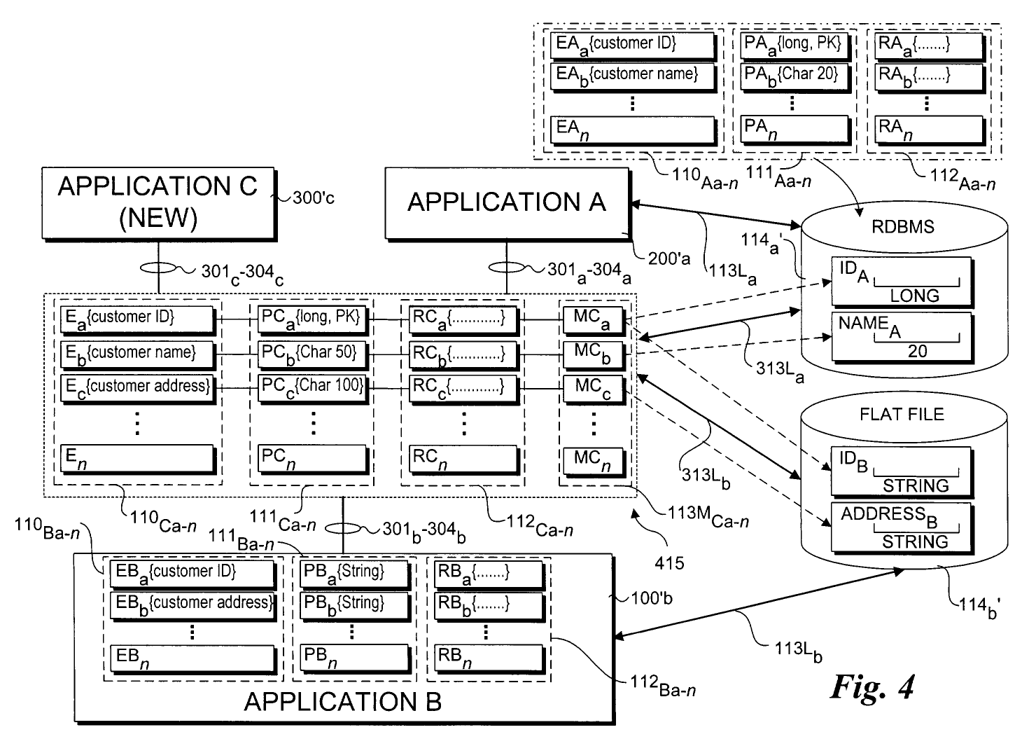

Another exemplary data architecture matrix 415 is shown in FIG. 4. In this example, data from two existing applications, application A 200′a and application B 100′b, are required for a new customer information application (application C 300′c). Application A 200′a is hosted by an RDBMS 114ₐ′. The RDBMS includes a table having columns corresponding to a customer ID data field having a long integer type and functioning as a primary key, and a customer name data field that has a 20 string type. Application B 100′b uses a flat file with tab-delimited fields for its data storage (flat file storage 114_{b}′), and employs customer ID and customer address fields having character string types.

By using the element definitions, including data entities, data properties, data relationships, and data mappings comprising matrix 415, the new application C can share the existing data hosted by RDBMS 114ₐ′ and flat file storage 114_{b}′, instead of replicating data into a new application data storage resource. In support of this mechanism, data architecture 415 is structured as a combination of the following components:

1) A set of data entities 110_{Ca-n}, comprising customer ID, customer name, and customer address. Note that data entities 110_{Ca-n} may comprise a superset of the data entities required for the new application, since although some of the data entities might not map directly into data fields present in the existing application, such data entities may be derived from existing fields of existing applications via combining data from multiple fields.

2) Set(s) of data properties 111_{Ca-n}. The data properties for the new application C have these characteristics: the customer ID is a long integer, the customer name is a character string that is 50 characters long, and the customer address is a character string that is 100 characters long. For application A, the customer ID is a long integer and the customer name is a character string that is 20 characters long. For application B, the customer ID and customer address are both a variable-length character strings. Depending on the particular implementation, sets of data properties for existing applications may also be included.

3) Set(s) of data relationships 112_{Ca-n}. In general, the data relationships define relationships between an application or applications and its/their data. For the new application C and application A, the data relationships are relational algebra based; while for application B, the data relationships are key-value pairs. The set(s) of data relationships may also include data relationships for existing applications, depending on the implementation.

4) Data access mechanisms 313Lₐ and 313L_{b}.

5) RDBMS data storage RDBMS 114ₐ and flat file data storage 114_{b}. These data stores hold the data accessed by applications A, B, and C. The may be accessed via respective access mechanisms 313Lₐ and 313L_{b}.

6) Data mappings defined by data maps 113M_{Ca-n}. These data maps provide A): mappings to physical data (i.e., application field data) stored by existing applications A and B in RDBMS data storage 114ₐ and flat file data storage 114_{b}, and B): logic, as appropriate, for combining data mapped from multiple existing fields into data entities for new application C and performing data-type conversion operations such that applications that employ data architecture matrix 415 “see” data having data types defined by properties 111_{Ca-n}, while the data is actually stored having the data type property defined by its corresponding host application.

Thus, by using the novel art of this disclosure, for the same application one skilled in the art can define a set of data entities, which can have different sets of data properties attached to a single data entity, with different sets of data relationships defined on them. The data entities then can be accessed through the different data access mechanisms and use different data storage, with more then one data storage location for a single data entity. Moreover, the data properties, data relationships, data access and data storage all can be of the different types and can be separately defined for the application

Although clearly advantageous, in some cases, however, the foregoing approach may not be directly applicable. The reality of the today's application deployment and integration environment is that the Logical Data Architecture often can be mapped to the existing Physical Data Architecture of the existing application(s) only through the set of the existing, predefined Transactions. In other words, the focus should be on the transaction definitions and mapping, not the data models and data mapping. Or, rather, it should be a combination of data mapping, for the systems that are open for direct data access, and transaction mapping, for the systems that only expose predefined transactions or API (application program interface).

It is always possible to map the logical data model to the physical one as long as the data entities of the logical data model represent a subset of the data entities of the physical data model (or can be deduced from them). In contrast, the mapping of the logical transactions to corresponding physical transactions cannot be done as easily. The logical transactions do not necessarily have the direct counterparts among the existing physical transactions. For example, you can have a logical transaction that updates two data elements of the logical data model, but the closest existing physical transaction updates three data elements of the physical data model.

The solution for this problem is a virtual transaction model that comprises several components: a logical transaction set, a physical transaction set, logical-to-physical transaction mapping, and session management and caching. The logical transaction set is a set of application requests performed on the logical data model. The physical transaction set is a set of existing transactions defined on the physical data model. Logical-to-physical transaction mapping is a set of operations and data transformations that link a logical transaction to one or more physical transactions. The session management and caching mechanism is introduced to solve the issue described above, that of the logical transactions not having an ideal match with existing physical transactions. The session is a set of logical and physical transactions that are needed to perform a unit of work, for example, to book a ticket, or update a customer address. Caching is primarily used to retrieve and store the data necessary for physical and logical transactions in the scope of the session. The core idea is to cache the information that is needed not only by the application itself (logical transactions), but by physical transactions as well, thus minimizing overall number of physical transactions.

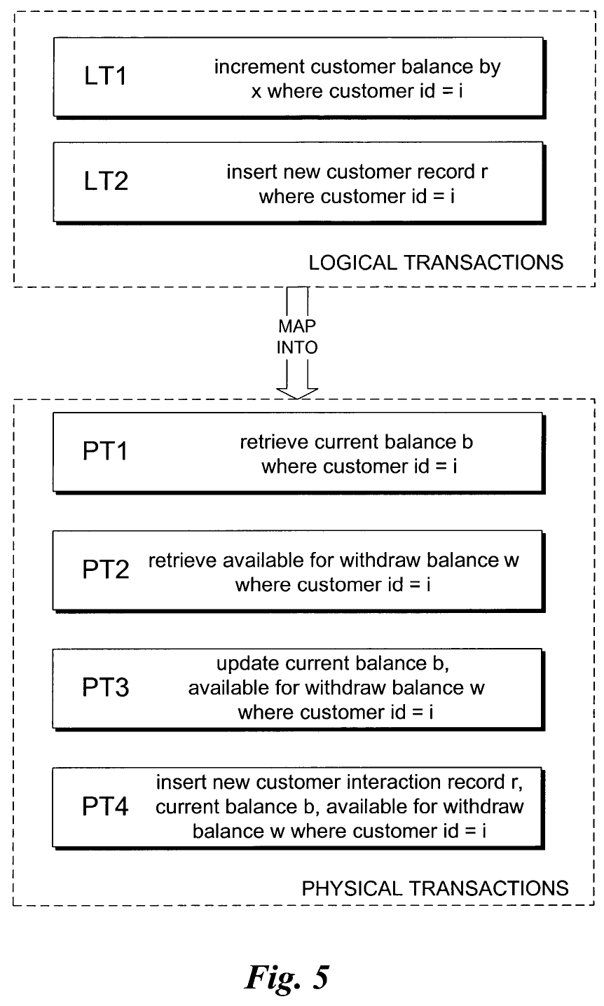

For example, consider the following logical transaction tasks in view of the existing physical transactions shown in FIG. 5:

start logical session

logical transaction 1 (LT1): increment customer balance by x where customer id=i

logical transaction 2 (LT2): insert new customer interaction record r where customer id=i

end logical session

Existing physical transactions:

physical transaction 1 (PT1): retrieve current balance b where customer id=i

physical transaction 2 (PT2): retrieve available for withdraw balance w where customer id=i

physical transaction 3 (PT3): update current balance b, available for withdraw balance w where customer id=i

physical transaction 4 (PT4): insert new customer interaction record r, current balance b, available for withdraw balance w where customer id=1

If logical transactions LT1 and LT2 are treated separately and mapped into physical transactions PT1-PT4, the following result is obtained.

LT1={PT1; b=b+x; PT2; if (check is cleared) w=w+x; PT3};

LT2={PT1, b=b+x, PT2; if (check is cleared) w=w+x; PT4};

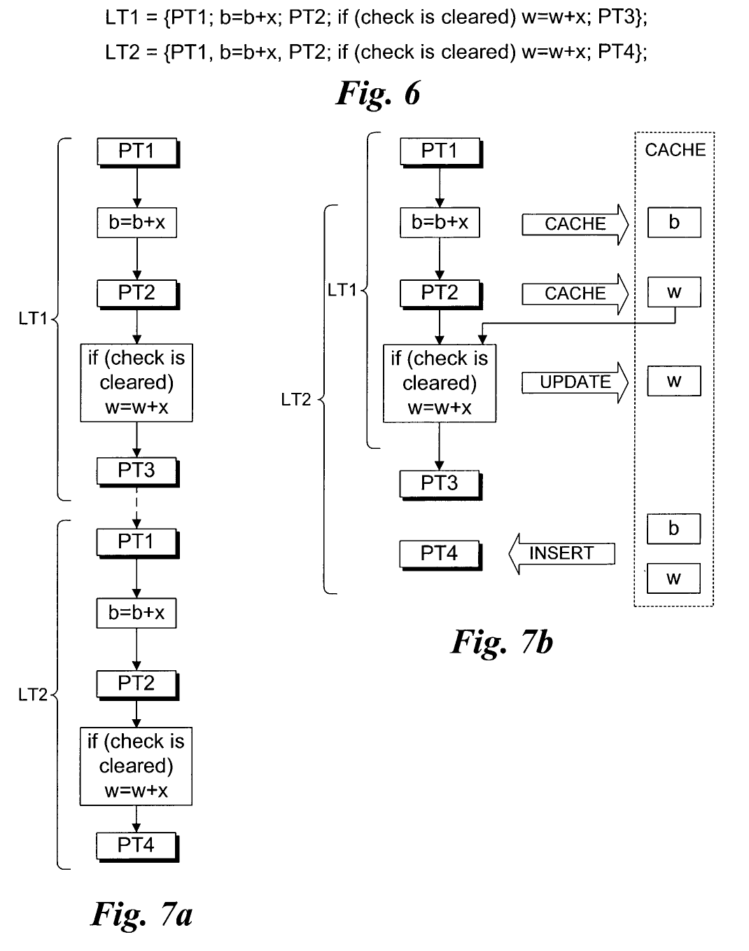

as shown in FIG. 6. This conventional approach produces the following sequence of transactions, as illustrated in FIG. 7a:

start physical session

PT1; b=b+x; PT2; if (check is cleared) w=w+x; PT3; PT1, b=b+x, PT2; if (check is cleared) w=w+x; PT4.

end physical session

In contrast, when the proposed approach is employed the following reduced set of transactions yield the same result:

start physical session

PT1; b=b+x; PT2; if (check is cleared) w=w+x; PT3; PT4

end physical session

The difference results from the fact that the logical and physical transactions sets, LTx and PTx, are not identical; namely, the physical transaction set PTx has data elements b and w, which are not present in the logical transaction set LTx. In accordance with the novel scheme disclosed herein, instead of retrieving the same data elements for every logical transaction, the system retrieves these data elements only once per session, thus decreasing the number of total transactions. In other words, all the data elements necessary for both the logical and physical transactions in the scope of the session are cached for the duration of the session.

This novel approach has the following advantages:

1. Elimination of application integration. With this approach of having a set of data accessors for different data architectures (RDBMS, flat files, hierarchical databases, screen data streams, accessors to existing packaged applications, etc.), integration becomes an exercise in mapping different data sets.

2. Elimination of data replication. Data don't need to be replicated into new application data storage. They can be reused in-place.

3. Real-time access to data. Since data are not replicated, the most recent copy of data is used from the original source.

4. Isolation of data from new application logic, so new applications may be created that can reuse existing applications and their data, thus supporting application and data migration.

5. Minimization of the overall number of the physical transactions.

### Exemplary Distributed Execution Environment

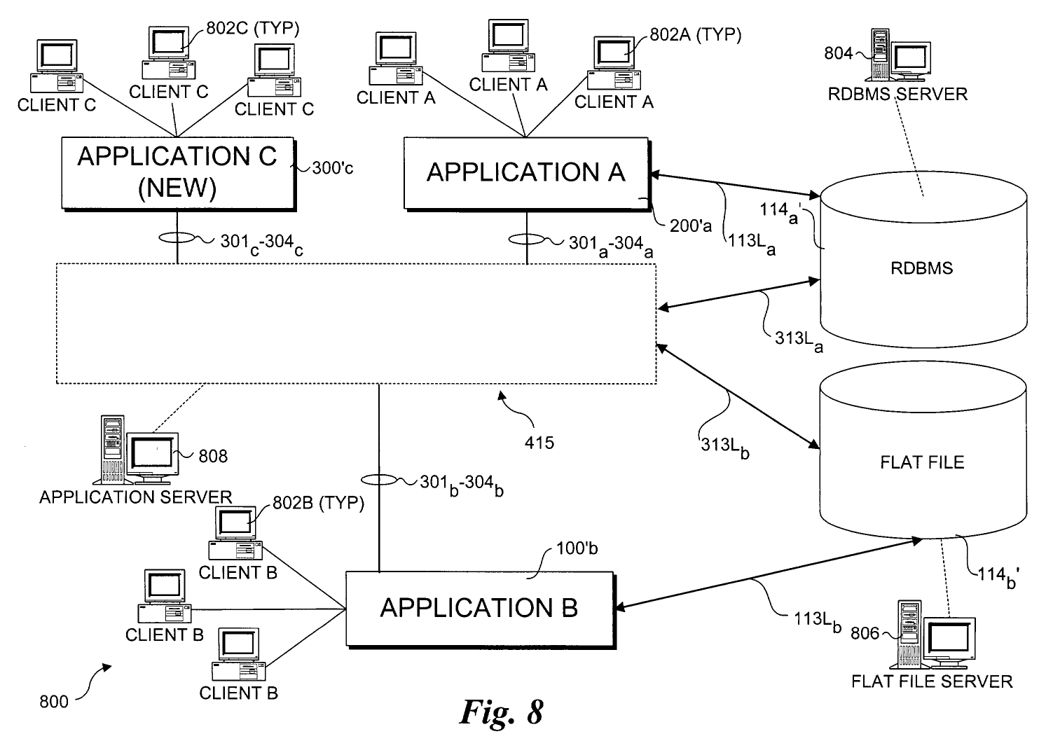

With reference to FIG. 8, an exemplary distributed execution environment 800 corresponding for implementing the data architecture of FIG. 4 is illustrated. Execution environment 800 (also known as a execution architecture or distributed hardware architecture) generally comprises a multi-tiered client-server architecture, as is well-known in the data system arts. Typically, each of applications A, B, and C will host a plurality of clients 802A, 802B, and 802C. For existing (e.g., legacy) applications A and B, the clients will typically be connected to a server used to host the application, wherein the application comprises a client-side component and a server-side component. For example, application A, which comprises an RDBMS-based application, is hosted on RDBMS server 804, which supports RDBMS data storage 114ₐ′. Similarly, application B, which comprises a flat-file application, is hosted by a flat file server 806. Although shown as single components, each of RDBMS and flat file servers may actually comprise a server front-end coupled to a enterprise-class storage means, such as a storage area network (SAN).

In general, each of application A's clients 802A will be connected to RDBMS server 804 via a respective client connection, depicted as data access mechanism 113Lₐ. Likewise, each of application B's clients 802B will be connected to flat file server 806 via a respective client connection, depicted as data access mechanism 113L_{b}. As will be recognized by those skilled in the art, either or both of applications A and B could be hosted by an application server that operates in a middle tier, wherein the clients interact with the application server and the application server interacts with the respective backend server (i.e., the RDBMS server and/or the flat file server).

In the illustrated embodiment, data architecture matrix 415 is hosted on an application server 808, while application C's clients are connected to application server 808 via respective client links (not shown). In turn, application server 808 is provided access to the legacy application (A and B) data hosted by RDBMS server 804and flat file server 806 via respective links 313Lₐ and 313L_{b}. Typically, these links may comprise privileged client link, as is common in the art, wherein the connection (in this case application server 808) provides special privileges (e.g., priority access, schema access, etc) and/or enhances bandwidth.

Generally, application C will provide a “virtual view” of the data stored in the data stores based on the element definitions in data architecture matrix 415. In this manner, application C can prevent views depicting data aggregated across different data stores and applications. Furthermore, new relationships between the data entities may be defined. All of this is transparent to application A and B and their corresponding application hosts. As a result, applications A and B can operate in their normal manner, without requiring any programming changes.

As discussed above, the data architecture scheme of the invention also enables existing applications to access new data sets, again without requiring replication or synchronization (in most instances). Thus, the data architecture scheme provides data sharing among applications without replication and synchronization, as well as separating the data architecture elements such that new relationships may be defined between existing data entities.

It is clear that a person skilled in the art may make modifications to the examples shown herein, without departing from the spirit of the invention. For example, in addition to being hosted by an application server, a data architecture matrix may be stored in a database itself, or may exist discretely among dispersed applications (virtual matrix). Other variations may include centralized or distributed control, and locking of active patterns at the data architecture matrix.

### Exemplary Computer Server for Implementing Software Aspects of the Invention

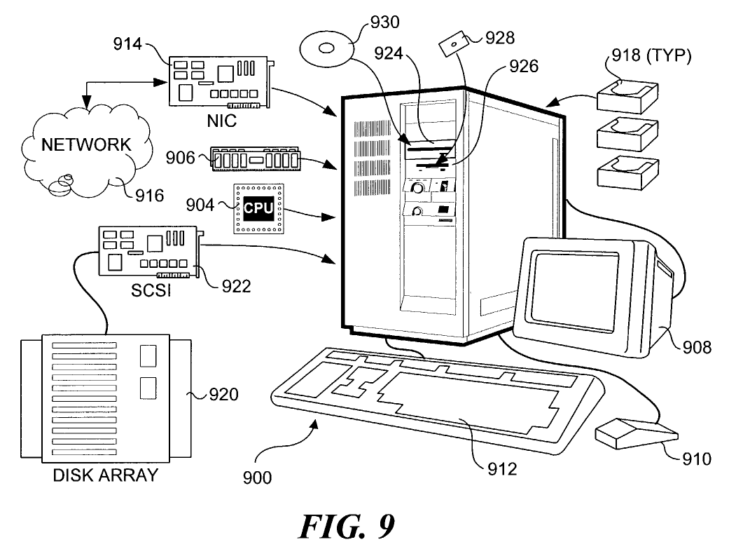

With reference to FIG. 9, a generally conventional computer server 900 is illustrated, which is suitable for use in connection with practicing the software aspects of the embodiments shown herein, and may be used for the servers the execution environment of FIG. 8. Examples of computer systems that may be suitable for these purposes include stand-alone and enterprise-class servers operating UNIX-based and LINUX-based operating systems, as well as servers running variants of Microsoft Windows server operating systems.

Computer server 900 includes a chassis 902 in which is mounted a motherboard (not shown) populated with appropriate integrated circuits, including one or more processors 904and memory (e.g., DIMMs or SIMMs) 906, as is generally well known to those of ordinary skill in the art. A monitor 908 is included for displaying graphics and text generated by software programs and program modules that are run by the computer server. A mouse 910 (or other pointing device) may be connected to a serial port (or to a bus port or USB port) on the rear of chassis 902, and signals from mouse 910 are conveyed to the motherboard to control a cursor on the display and to select text, menu options, and graphic components displayed on monitor 908 by software programs and modules executing on the computer. In addition, a keyboard 912 is coupled to the motherboard for user entry of text and commands that affect the running of software programs executing on the computer. Computer server 900 also includes a network interface card (NIC) 914, or equivalent circuitry built into the motherboard to enable the server to send and receive data via a network 916.

File system storage corresponding to the invention may be implemented via a plurality of hard disks 918 that are stored internally within chassis 902, and/or via a plurality of hard disks that are stored in an external disk array 920 that may be accessed via a SCSI card 922 or equivalent SCSI circuitry built into the motherboard. Optionally, disk array 920 may be accessed using a Fibre Channel link using an appropriate Fibre Channel interface card (not shown) or built-in circuitry.

Computer server 900 generally may include a compact disk-read only memory (CD-ROM) drive 924 into which a CD-ROM disk may be inserted so that executable files and data on the disk can be read for transfer into memory 906 and/or into storage on hard disk 918. Similarly, a floppy drive 926 may be provided for such purposes. Other mass memory storage devices such as an optical recorded medium or DVD drive may also be included. The machine instructions comprising the software program that causes processor(s) 904 to implement the functions of the present invention that have been discussed above will typically be distributed on floppy disks 928 or CD-ROMs 930 (or other memory media) and stored in one or more hard disks 918 until loaded into memory 906 for execution by processor(s) 904. Optionally, the machine instructions may be loaded via network 916.

Thus, embodiments of this invention may be used as or to support a software program or modules executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for accessing data, comprising:
defining a set of data mappings between data entities included in a first set of data entities corresponding to a first application and existing data entities corresponding to one or more existing applications on an individual data entity basis;
requesting data access to at least one data entity via the first application; and
retrieving data corresponding to existing data entities based on the data mappings defined for said at least one data entity.

2. The method of claim 1, further comprising defining a set of data properties for the first set of data entities, wherein at least a portion of the first data entities have data properties defined for them that are different than data properties for existing data entities they are mapped to.

3. The method of claim 1, wherein the data mapping for a given data entity for the first application maps into at least two different existing data entities.

4. The method of claim 3, wherein said at least two different existing data entities correspond to at least two different existing applications.

5. The method of claim 1, wherein said one or more existing applications are hosted by respective servers, further comprising defining data access mechanisms via which data may be retrieved from the respective servers.

6. The method of claim 1, wherein the first set of data entities are mapped into existing data entities corresponding to at least two existing applications that employ different data relationship schemes.

7. The method of claim 6, wherein the different data relationship schemes include a relational database management system (RDBMS) data relationship scheme and a flat-file relationships scheme.

8. The method of claim 1, further comprising defining a set of data relationships between data entities in the first set of data entities.

9. The method of claim 1, wherein the first set of data entities and the set of data mappings are stored as a data architecture matrix.

10. A method or claim 1, further comprising:
defining a set of logical data transactions employing the first set of data entities and corresponding to a logical data model for the first application;
identifying a set of physical data transactions employing a existing data entities corresponding to a physical data model for an existing application; and
defining a set of logical-to-physical data transaction mappings comprising a set of operations and data transformations that link each logical transaction with one or more physical transactions.

11. A data architecture comprising:
a set of data entities; and
a set of data maps, mapping each data entity among the set of data entities to at least one existing data entity corresponding to at least one existing application.

12. The data architecture of claim 10, wherein the data mapping for at least one data entity maps to data from at least two different existing data entities.

13. The data architecture of claim 10, further comprising a set of data properties, wherein each data entity has a corresponding data property.

14. The data architecture of claim 10, further comprising a set of data relationships that define relationships between the data entities.

15. The data architecture of claim 13, wherein the set of data relationships include data relationships corresponding to at least two different data relationship schemes.

16. The data architecture of claim 10, further comprising a set of data access mechanisms to provide access to data corresponding to the existing data entities.

17. A method for performing data transactions comprising:
defining a set of logical data transactions employing a first set of data elements corresponding to a logical data model for a first application;
identifying a set of physical data transactions employing a second set of data elements corresponding to a physical data model for an existing application, at least one data element in the second set of data elements not being included in the first set of data elements; and
defining a set of logical-to-physical data transaction mappings comprising a set of operations and data transformations that link each logical transaction with one or more physical transactions.

18. The method of claim 17, further comprising performing a logical data transaction through implementation of the logical-to-physical transaction mapping defined for that logical data transaction.

19. The method of claim 17, further comprising:
identifying physical model data elements that are accessed more than once during the performance of the logical data transaction; and
modifying the logical-to-physical transaction mapping for the logical transaction to employ cached data values corresponding the identified data elements.

20. The method of claim 19, further comprising performing a logical data transaction through implementation of the modified logical-to-physical transaction mapping defined for that logical data transaction, wherein the data corresponding to the identified physical model data elements are cached during a logical data transaction session.
